(19) United States
(12) Patent Application Publication
(10) Pub. No.: US 2011/0091361 A1
(43) Pub. Date: Apr. 21, 2011

(54) Filter for removing particles from a gas stream and method for the manufacture thereof

(76) Inventors: Bernd Reinsch, Ludwigsburg (DE); Christoph Saffe, Weil Der Stadt (DE)

(21) Appl. No.: 12/310,582

(22) PCT Filed: Jul. 10, 2007
(86) PCT No.: PCT/EP2007/057056

§ 371 Date: Sep. 16, 2010

(30) Foreign Application Priority Data
Aug. 31, 2006 (DE) 10 2006 040 739.3

(51) Int. Cl. B01J 8/02; B01D 39/20; B05D 5/00

(52) U.S. Cl. 422/211; 55/486; 427/287

(57) ABSTRACT

A filter for removing particles from a gas stream, in particular soot particulate from an exhaust-gas stream of an internal combustion engine, including a filter body composed of a ceramic filter substrate, the filter substrate being coated with a porous protective layer of a coating material. The coating material contains an admixture of 1 to 20% by weight of at least one compound of an element of the second main group, which may be of an oxide of an element of the second main group, and cracks contained in the ceramic filter substrate are partially filled with the coating material. In addition, a method for manufacturing a filter, where the coating material for the porous protective layer is applied to the sintered, ceramic filter substrate, at least one compound of an element of the second main group is added, optionally other substances contained in the protective layer are added, and the porous protective layer is fixed.

### BACKGROUND INFORMATION

The present invention relates to a filter for removing particles from a gas stream according to the definition of the species set forth in claim 1, as well as to a method for manufacturing the filter.

Filters of this kind are used, for example, in the exhaust-gas aftertreatment of self-igniting combustion engines, in particular in Diesel-powered motor vehicles. Filters of this kind for removing particles, which are generally referred to as particulate filters, are typically manufactured from a ceramic material, such as silicon carbide, aluminum titanate or cordierite. The particulate filters are generally designed in the form of a honeycomb ceramic having channels that are sealed at alternate opposite ends. Particulate filters of this kind exhibit a filtration efficiency of more than 80% up to regularly greater than 90%. However, difficulties arise not only in the filtration of the soot particulate, but also in the regeneration of the filter. To this end, fuel or its decomposition products are catalytically oxidized in an exhaust-gas aftertreatment system, which includes the particulate filter, in order to generate the temperatures required for igniting the soot. During the hotter regeneration phases, the highest demands are placed on the thermal stability of the filter. A filter of this kind is known, for example, from U.S. Pat. No. 6,898,930. In order to convert gaseous pollutants contained in the exhaust gas, the Diesel particulate filter described in U.S. Pat. No. 6,898,930 can be provided with a coating containing a catalytically active material, for example a noble metal.

Ceramic filter materials generally have microcracks which contribute to the thermal stability of the filter. In simplified terms, these are to be understood as “expansion joints,” since they close in response to thermal material expansion and thereby reduce the thermally induced stresses in the filter component. With an increasing number of microcracks, the coefficient of thermal expansion and the thermal conductivity of the ceramic filter decrease. If particles penetrate into the microcracks of the filter material, this can limit the “expansion joint” stabilizing effect. Consequently, these types of ceramic filters have a higher probability of failure, particularly when subjected to a high thermal load and especially when they are made of the filter materials cordierite or aluminum titanate.

From U.S. Pat. No. 4,532,228, a catalyst of a ceramic material is known, where, prior to the application of a coating, microcracks in the ceramic material are filled with an organic substance to prevent the coating from penetrating into the same. Following application of the coating, the organic substance is removed by burning out of the same. From U.S. Pat. No. 4,451,517, it is also known, in the case of a catalyst having a honeycomb structure, to seal microcracks in the ceramic with an organic substance, prior to the application of a coating of aluminum oxide. Thus, both U.S. Pat. No. 4,532,228, as well as U.S. Pat. No. 4,451,517 intend in this manner to prevent coating material from being able to penetrate into the microcracks.

### SUMMARY OF THE INVENTION

### Advantages of the Invention

A filter designed in accordance with the present invention for removing Particles from a gas stream, in particular soot particulate from an exhaust-gas stream of an internal combustion engine, includes a filter body composed of a ceramic filter substrate, the filter substrate being coated with a porous protective layer of a coating material. In accordance with the present invention, the coating material contains an admixture of 1 to 20% by weight of at least one compound of an element of the second main group, preferably of an oxide of an element of the second main group; and cracks contained in the ceramic filter substrate are partially filled with the coating material.

By partially filling the cracks in the ceramic filter substrate, particles are prevented from being able to penetrate into the same. This enhances the stability of the filter.

Once the cracks in the ceramic filter substrate have been partially filled, the protective layer may be present in the form of a thin film or a thin layer on the filter substrate.

The thermal stability of the protective layer is increased by adding the at least one compound of an element of the second main group.

The coating material for the porous protective layer is preferably selected from the group consisting of aluminum oxide, aluminum hydroxide, titanium dioxide, silicon dioxide, zirconium dioxide, cerium dioxide, aluminum silicates, magnesium aluminum silicates, cordierite, mullites, silicon carbide, aluminum titanate, zeolites, quartz, glass and blends thereof. The coating material for the porous protective layer is preferably selected from the group consisting of aluminum oxide, aluminum hydroxide, titanium dioxide, silicon dioxide, zirconium dioxide, cerium dioxide, blends and mixed oxides thereof. Mixed oxides of aluminum oxide and silicon oxide having a mass proportion of up to 15% by weight of silicon dioxide in relation to aluminum oxide, silicon-rich zeolites or mixed oxides of cerium dioxide and zirconium oxide are thus suited, for example.

In one preferred specific embodiment, the coating material for the porous protective layer also includes at least one alkali metal compound, preferably an alkali metal oxide for adjusting the morphology of the protective layer. The proportion of the at least one alkali metal compound in relation to the coating material is preferably up to 0.5% by weight.

In addition, the coating material for the porous protective layer may also contain at least one compound of an element of the third to the fifth B group or of the lanthanoids, including the lanthanum, preferably an oxide of an element of the third to the fifth B group or of the lanthanoids, including the lanthanum. The proportion of the compound of the element of the third to the fifth B group or of the lanthanoids, including the lanthanum, is preferably within the region of up to 5% by weight. The thermal stability of the support material is further enhanced by adding the compound of an element of the third to the fifth B group or of the lanthanoids, including the lanthanum.

Blends of the substances for the porous protective layer are possible in all proportions. Thus, for example, blends of aluminum oxide having up to 18% by weight of BaO, 0.03% by weight of K₂O, 6% by weight of CeO₂ and 8% by weight of ZrO₂ are preferred.

In another specific embodiment, at least one further protective layer is deposited on the porous protective layer. In this context, the porous protective layers may be composed of the same or of different materials. The individual porous protective layers may fulfill different functions. It is also possible, for example, for two or more different porous protective layers to be applied one over the other in alternating sequence.

In one specific embodiment, at least one of the porous protective layers contains a catalytically active component. Suited as a catalytically active component is/are, preferably, a metal or a plurality of metals from the group of the platinum metals, preferably platinum, rhodium and/or palladium. In this context, the catalytically active component may be contained in the porous protective layer which coats the ceramic filter substrate, or in one of the protective layers deposited thereon. It is also possible for only one porous protective layer, which contains the catalytically active substance, to be deposited on the ceramic filter substrate.

With the aid of the catalytically active substance, gaseous pollutants, such as unburned fuel, its decomposition products, such as carbon monoxide, as well as nitrogen oxides, sulphur dioxides, and soot may be catalytically stored or converted. The catalytic function is suited for resisting the thermochemical attack of exhaust-gas components.

The at least one catalytically active component is treated in a manner customarily used to produce catalytic converters. Blends of a plurality of catalytically active substances in one porous protective layer or also a plurality of different catalytically active substances on different porous protective layers may be used. The catalytically active substances, preferably noble metals, may also be present as alloys or blends.

In one specific embodiment, the porous protective layer is deposited in the outflow side and/or in the center region of the filter. It is also possible that individual regions of the filter substrate are coated with different layers, quantities or layer sequences.

In another specific embodiment, the porous protective layer is deposited in the inflow-side region of the filter. In addition, special applications permit or require that the deposition take place on radial peripheral regions of the filter.

In the case of the finished filter, the coating materials are preferably present in the form of their oxides. However, it is also possible that the coating materials are present in the form of their nitrates, hydroxides, acetates, oxalates, carbonates or similar compounds. Generally, however, under the operating conditions of the filter, these compounds decompose, at least temporarily, to oxides. Furthermore, under the operating conditions of the filter, it is also possible that these compounds are temporarily formed from the oxides.

The method according to the present invention for manufacturing a filter for removing particles from a gas stream includes the following steps:
(a) adding the at least one compound of an element of the second main group in the form of a solid, a gel, a salt solution, a hydrosol, or a blend thereof;
(b) applying the coating material for the porous protective layer to the sintered, ceramic filter substrate;
(c) optionally adding other substances contained in the coating;
(d) fixing the porous protective layer.

In the pulverulent form, the coating material used to produce the porous protective layer preferably has a BET surface of more than 10 m²/g and a pore volume in the range of 0.1 to 1.5 ml/g. The average particle size (D50) of the coating materials suited for producing the protective layer varies within a broad range. Especially suited are particles of a size of 2 nm up to 20 μm. Most particularly suited are particles of a size of more than 1 μm. The particles suited for coating may be obtained, for example, by precipitation or by pyrolytic processes. Grinding or precipitation processes are suited, for example, for adjusting the particle size and the particle size distribution. Any other processes known to one skilled in the art for adjusting particle size and particle size distribution are also possible. For example, inorganic salt solutions and organometallic solutions may be used as precursors to adjust the particle size and the particle size distribution when precipitation processes are used.

Suitable coatings are formed, for example, by combining different sized particles, sometimes having bi- or polymodal particle size distribution.

The coating material for the porous protective layer is preferably applied in a sol-gel process, as preformed sol or gel, or as a suspension of solid particles. The rheological properties of this coating mass and the particle size distribution are adjusted in the process in such a way that the coating mass is suited for partially filling the cracks in the ceramic filter substrate.

The coating material used for the porous protective layer may be applied using all coating processes known to one skilled in the art. Suitable coating processes include spraying, immersion, saturation or the like. Vacuum- or pressure-based coating processes are also suited.

Besides aqueous solutions, hydrosols, hydrogels or aqueous suspensions, those organosols, organogels or organic solutions or dispersions, which have a lower surface tension than their aqueous homologues, are also suited for applying the coating material used for the porous protective layer. Also suited, in particular, are aqueous media whose surface tension has been reduced by inorganic or organic additives. Suitable additives are, for example, long-chain alcohols and tensides.

The at least one compound of an element of the second main group or also the other substances optionally contained in the protective layer, for example the at least one alkali metal compound, the compound of an element of the third to fifth B group or of the lanthanoids, including lanthanum, or the catalytically active component, is/are added, for example, in the form of a solid, for example as an oxide, mixed oxide, hydroxide or salt, preferably carbonate, nitrate or acetate, and/or as a gel, for example as a hydroxide, as a salt solution, preferably as a carbonate, nitrate or acetate, or as a hydrosol. The at least one compound of an element of the second main group, as well as the other substances optionally contained in the coating may be added to the raw material of the coating material, the coating mass or the finished coating. In this context, the adding process may be carried out using any given manner known to one skilled in the art.

The porous protective layer is fixed in step (d) using established methods known to one skilled in the art. Suitable methods include, for example, drying, calcining and sintering.

The quantity of coating materials to be applied to form the porous protective layer may vary within a broad range. The loading of the filter with the coating material is carried out as a function of the filter volume and amounts to 1 g/l to 200 g/l, preferably 10 to 150 g/l, relative to the total filter volume.

### BRIEF DESCRIPTION OF THE DRAWING

Exemplary embodiments of the present invention are illustrated in the drawing and explained in detail in the following description.

In the drawing,

FIG. 1 shows a schematic representation of a combustion engine having an exhaust-gas aftertreatment device in accordance with the present invention;

FIG. 2 shows a filter element according to the present invention in longitudinal section;

FIG. 3 shows a schematic representation of the coated filter substrate including one layer;

FIG. 4 shows exemplarily a granule of the filter substrate having a coating in a plurality of layers.

### DETAILED DESCRIPTION

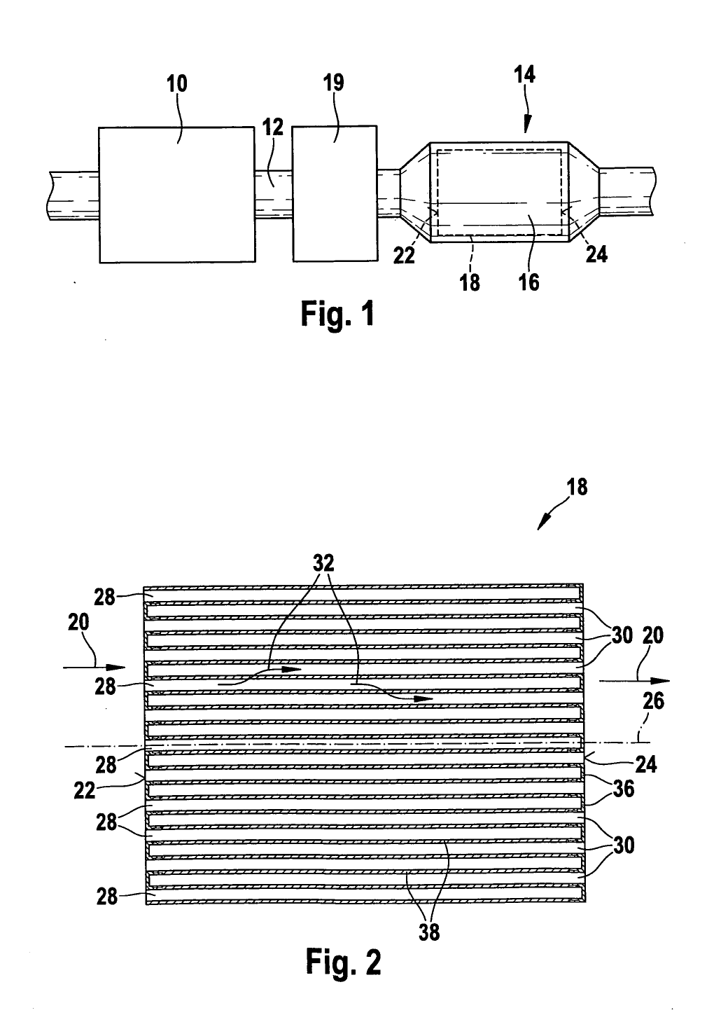

FIG. 1 shows a schematic representation of a combustion engine having an exhaust-gas aftertreatment device in accordance with the present invention. In this case, the exhaust-gas aftertreatment device is a filter in which soot particulate is removed from the exhaust-gas stream.

A combustion engine 10 is coupled via an exhaust pipe 12 within which a filter device 14 is mounted. The system optionally includes one or more catalytic converters 19 which are configured upstream of filter device 14. Filter device 14 is used to filter soot particulate out of the exhaust gas flowing in exhaust pipe 12. This is particularly necessary when woring with Diesel engines in order to observe the legal regulations.

Filter device 14 includes a cylindrical housing 16 having a filter element 18 mounted therein, which, in the present exemplary embodiment is rotationally symmetric and, overall, therefore is likewise cylindrical.

FIG. 2 shows a filter element according to the present invention in longitudinal section.

Filter element 18 is produced, for example, as an extruded molded article of a ceramic material, for example magnesium aluminum silicate, preferably cordierite. Filter element 18 is traversed by the flow of exhaust gas in the direction of arrows 20. The exhaust gas enters via an inlet surface 22 into filter element 18 and exits the same via an outlet surface 24.

Extending in parallel to a longitudinal axis 26 of filter element 18 are a plurality of inlet channels 28 which alternate with outlet channels 30. Inlet channels 28 are sealed at outlet surface 24. For this purpose, sealing plugs 36 are provided in the specific embodiment described here.

Accordingly, outlet channels 30 are open at outlet surface 24 and sealed in the area of inlet surface 22.

Thus, the flow path of the unpurified exhaust gas leads into one of inlet channels 38 and, from there, through a filter wall 38 into one of outlet channels 30. This is shown exemplarily by arrows 32.

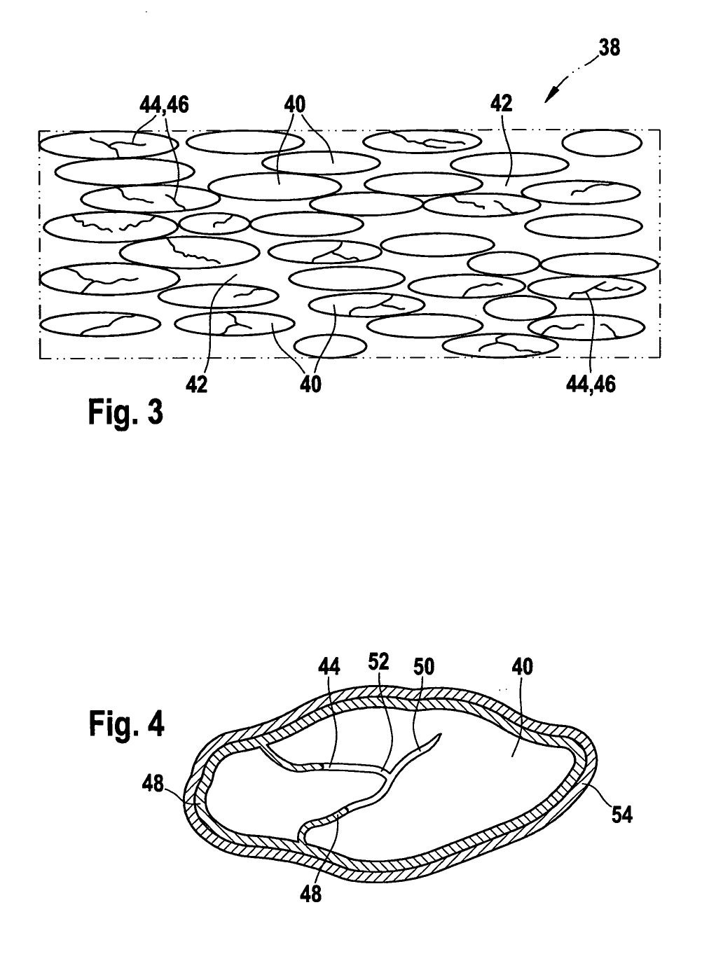

FIG. 3 shows a schematic representation of the coated filter substrate having a layer. A filter wall 38 is fabricated from a ceramic filter substrate. The ceramic filter substrate is composed of individual granules 40 which are generally bonded to one another by sintering. The ceramic filter substrate is preferably silicon carbide, aluminum titanate, mullite or cordierite. Blends of these materials are also possible. Located between individual granules 40 of the ceramic filter substrate are pores 42 which are traversed by the flow of the gas stream to be purified. Particles, which are contained in the gas stream, are held back by the ceramic filter substrate of filter wall 38. The particles, which are removed from the gas stream, also settle in pores 42. This reduces the free cross section of filter wall 38, and the pressure loss across filter wall 38 increases. For this reason, it is necessary to remove the particles from the pores in regular intervals. This is generally accomplished by thermal regeneration in that the filter is heated to a temperature of more than 600° C. At this temperature, the organic particles typically burn to carbon dioxide and water and are discharged from the particulate filter in a gaseous form.

Microcracks 44 are generally contained in the individual granules. Microcracks 44 contribute to the thermal stability of the filter. In response to a thermal material expansion, microcracks 44 close and thereby reduce the thermally induced stresses in filter wall 38. With an increasing number of microcracks 44, the coefficient of thermal expansion and the thermal conductivity of ceramic filter 14 decrease. However, if particles penetrate into microcracks 44 in granules 40, it can happen that the stabilizing effect is reduced since microcracks 44 are no longer able to close in response to thermal material expansion. This increases the thermally induced stresses in the granules. The stresses that occur can lead to tearing of filter wall 38.

To prevent particles from penetrating into microcracks 44, they are partially filled with a porous protective layer 46. As already explained above, the material for the porous protective layer is preferably selected from the group consisting of aluminum oxide, aluminum hydroxide, titanium dioxide, silicon dioxide, zirconium dioxide, cerium dioxide, aluminum silicates, magnesium aluminum silicates, cordierite, mullites, silicon carbide, aluminum titanate, zeolites, quartz, glass and blends thereof and mixed oxides. 1 to 20% by weight of at least one compound of an element of the second main group, preferably of an oxide of an element of the second main group, are admixed with the coating material. In addition, the porous protective coating may contain alkali metal compounds or compounds of an element of the third to the fifth B group or of the lanthanoids, including the lanthanum.

Besides the at least partially filled microcracks 44, the coating material may also form a thin layer or a film on granules 40 of the filter substrate. In particular, when the coating material also forms a thin film or a thin layer on granules 40 of the filter substrate, the ceramic coating may also contain at least one catalytically active material. Suited as a catalytically active material are, in particular, noble metals from the group of the platinum metals, such as platinum, rhodium or palladium, for example. With the aid of the catalytically active material contained in the coating, gaseous pollutants and soot particulate are stored and thermocatalytically converted. The conversion of the gaseous pollutants is generally exothermic, so that reaction heat is thereby liberated. This reaction heat contributes to the exhaust-gas temperature required for regenerating the filter being reached.

The rheological properties and, as the case may be, the granule sizes of the particles contained in the coating mass are preferably adjusted to allow portions of the coating material to also penetrate into microcracks 44. In this context, the coating material is preferably applied in a solgel process, as preformed sol or gel, or as a suspension of solid particles.

A granule 40 of the filter substrate having a coating of two layers is illustrated in FIG. 4. A microcrack 44 is formed in granule 40.

Granule 40 illustrated here includes a first protective layer 48, which is composed of a coating material as described above. Microcrack 44 contained in granule 40 is also partially filled with coating material 48. Both microcrack 44, as well as a branch 50 of microcrack 44 contain an unfilled region 52 that was not filled by the coating material.

In the specific embodiment illustrated here, granule 40 is completely covered by first layer 48. The thermal and hydrothermal stability of granule 40 are enhanced by first layer 48, which has also partially filled microcrack 44. In the specific embodiment illustrated here, a second layer 54 is deposited onto first layer 48. Second layer 54 is likewise essentially composed of a ceramic or mineral oxide, as described above. It is also possible that either first layer 48 or second layer 54 contains a catalytically active material. First layer 48 and second layer 54 may also both contain the catalytically active material. It is also possible that first layer 48 and second layer 54 are made of the same coating material. However, first layer 48 and second layer 54 may also be produced from different coating materials.

Besides the specific embodiment shown in FIG. 4, it is also possible for at least one further porous protective layer to be deposited onto second layer 54. In this context, it is possible that the protective layers composed of two different coating materials are deposited onto granule 40 in an alternating sequence. In addition, it is also possible that each protective layer has a different composition or is composed of a different coating material. However, it is also possible that the protective layers are all made of the same material or have the same composition. The number of layers applied to granule 40 is freely selectable and is only limited by the desired pore size still present following the coating process.

1-16. (canceled)

17. A filter for removing particles from a gas stream, comprising:
a ceramic filter substrate; and
a filter body having the ceramic filter substrate so as to provide a filter substrate, wherein the filter substrate is coated with a porous protective layer of a coating material, wherein the coating material contains an admixture of 1 to 20% by weight of at least one compound of an element of a second main group, and wherein cracks contained in the ceramic filter substrate are partially filled with the coating material.

18. The filter of claim 17, wherein the coating material for the porous protective layer is selected from the group consisting of aluminum oxide, aluminum hydroxide, titanium dioxide, silicon dioxide, zirconium dioxide, cerium dioxide, aluminum silicates, magnesium aluminum silicates, cordierite, mullites, silicon carbide, aluminum titanate, zeolites, quartz, glass, and blends and mixed oxides thereof.

19. The filter of claim 18, wherein the coating material for the porous protective layer also includes at least one of an alkali metal compound and an alkali metal oxide.

20. The filter of claim 17, wherein the coating material for the porous protective layer also contains at least one compound of an element of the third to the fifth B group or of the lanthanoids, including the lanthanum.

21. The filter of claim 17, wherein at least one further porous protective layer is deposited on the porous protective layer.

22. The filter of claim 21, wherein the porous protective layers, which are deposited one over the other, fulfill different functions.

23. The filter of claim 17, wherein at least one of the porous protective layers contains a catalytically active component, preferably a metal or a plurality of metals from the group of the platinum metals, preferably platinum and/or palladium.

24. The filter of claim 17, wherein the at least one porous protective layer is deposited at least one of in an outflow side and in a center region of the filter.

25. The filter of claim 17, wherein the at least one porous protective layer is deposited at least one of in an inflow side and in a radially outer region of the filter.

26. The filter of claim 17, wherein individual regions of the filter substrate are coated with different layers, quantities or layer sequences.

27. A method for manufacturing a filter for removing particles from a gas stream, the method comprising:
(a) adding at least one compound of an element of the second main group in the form of at least one of a solid and one of a gel, a salt solution and a hydrosol;
(b) applying a coating material for a porous protective layer to a sintered, ceramic filter substrate;
(c) optionally adding other substances contained in the protective layer; and
(d) fixing the porous protective layer;
wherein the filter includes a filter body having the ceramic filter substrate so as to provide a filter substrate, wherein the filter substrate is coated with a porous protective layer of a coating material, wherein the coating material contains an admixture of 1 to 20% by weight of at least one compound of an element of the second main group, and wherein cracks contained in the ceramic filter substrate are partially filled with the coating material

28. The method of claim 27, wherein, in the pulverulent form, the coating material has a BET surface of more than 10 m²/g and a pore volume in the range of 0.1 to 1.5 ml/g.

29. The method of claim 27, wherein the coating material has a particle size within the range of 2 nm to 20 μm.

30. The method of claim 27, wherein the porous protective layer is applied in a sol-gel process, as a preformed sol or gel, or as a suspension of solid particles.

31. The method of claim 27, wherein the at least one compound of an element of the second main group, as well as the other substances optionally contained in the coating are added to the raw material of the coating material, the coating mass or the finished coating.

32. The method of claim 27, wherein at least one further porous protective layer is deposited onto the first porous protective layer, either each porous protective layer being initially fixed before the coating material of the subsequent layer is deposited, or the coating material for at least two layers being first deposited and subsequently jointly fixed.

33. The method of claim 27, wherein the coating material has a particle size greater than 1 μm.

34. The filter of claim 17, wherein the particles are soot particulate from an exhaust-gas stream of an internal combustion engine.

35. The filter of claim 17, wherein the at least one compound includes an oxide of the element.

36. The filter of claim 20, wherein the coating material for the porous protective layer also contains at least one compound of an oxide of the third to the fifth B group or of the lanthanoids, including the lanthanum.

37. The filter of claim 23, wherein the catalytically active component includes a metal or a plurality of metals from the group of the platinum metals.

38. The filter of claim 23, wherein the catalytically active component includes a metal or a plurality of metals from at least one of platinum and palladium.
